(19) United States
(12) Patent Application Publication
(10) Pub. No.: US 2023/0030047 A1
(43) Pub. Date: Feb. 2, 2023

(54) CABLE TRAY

(71) Applicant: CMS Electracom Limited, Harpenden (GB)

(72) Inventor: Shaun Roussel, Harpenden (GB)

(21) Appl. No.: 17/876,911

(22) Filed: Jul. 29, 2022

(30) Foreign Application Priority Data
Jul. 30, 2021 (GB) 2110979.8

(51) Int. Cl. A47B 21/06

(52) U.S. Cl. CPC A47B 21/06

(57) ABSTRACT

A cable tray (11) for under desk storage of electric cables (13) is disclosed. The tray takes the form of a container (41) and a pair of elongate tray supports (15), the upper end of which is attached to the underside of a desktop (10). Each tray support (15) has a groove (20) in which is retained a stub axle (30) connected to the container (41). The groove (20) has a cylindrical portion (21) at its lower end and a recurvate portion at its upper end. The container (41) is movable between a top storage position in which the stub axles are located in the upper recurvate portions (23) and a bottom access position in which the stub axles are located. in the cylindrical portions (21) which function as a bearing and permit the container to be tilted about the stub axles.

### FIELD OF THE INVENTION

The present invention relates to cable trays for under desk storage.

### BACKGROUND ART

The modern office environment requires that desks be provided with a considerable amount of electrical equipment including computers, computer screens, keyboards, charging outlets and like electrical equipment. Whilst this equipment is required to be located on the desktop in order to be accessible to the user, this desktop electrical equipment gives rise to a large amount of ancillary equipment such as electric cables, cords, double adapters, connectors, power boards, chargers and the like which should not be on the desktop and thus needs to be stored somewhere out of the way but adjacent the desktop. This is normally achieved by means of a grommet lining a hole in the desktop and through which the electric cables pass. These electric cables extend into a cable tray which is rigidly secured to the underside of the desk and which supports the ancillary equipment.

From time to time it is necessary to make adjustments to the ancillary equipment and this normally involve someone accessing the cable tray on their hands and knees. This is particularly problematic for those wearing constrictive garments such as ladies wearing tight skirts.

### GENESIS OF THE INVENTION

The Genesis of the present invention is a desire to improve the access to the ancillary equipment to permit such adjustments to be more easily made.

### SUMMARY OF THE INVENTION

In accordance with a first aspect of the present invention there is disclosed a cable tray for under desk storage of electric cables, cords, double adapters, connectors, chargers and like superfluous electric equipment not required on the desktop, said cable tray comprising a container having a base, a pair of sides, a front and a rear, adjacent each of said sides is an elongate tray support which has a longitudinal axis, an upper end shaped to be secured to the underside of said desk, a slot in said tray support extending along said longitudinal axis, and a stub axle connected to the adjacent side and being slidably engaged with said slot, wherein the upper end of each said slot is recurvate whereby by sliding said stub axles along said slots said container is movable between a top storage position in which said stub axles are located in upper recurvate portions of said grooves, and a bottom access position in which said stub axles are located at lower ends of said grooves and in which said container is tiltable about said stub axles to facilitate access to the container contents.

According to another aspect of the present invention there is provided a method of accessing a cable tray located beneath a desk, said method comprising the steps of lowering and tilting said cable tray.

In accordance with another aspect of the present invention there is disclosed a desk incorporating the above-mentioned cable tray.

### BRIEF DESCRIPTION OF THE DRAWINGS

A preferred embodiment of the invention will now be described, by way of example only, with reference to the accompanying drawings in which:

FIG. 1 is a perspective view from above of the cable tray of the preferred embodiment with part of the desktop being cut away and the cable tray being in the access position,

FIG. 2 is a perspective view without the desktop and showing the cable tray in the storage position,

FIG. 3 is a side elevation showing the cable tray in the storage position,

FIG. 4 is a side elevation as for FIG. 3 but illustrating the cable tray in the tilted access position, and

FIG. 5 is a front view of the desktop illustrating the installed cable tray in its storage position in solid lines, and illustrating the cable tray in the tilted access position in broken lines.

### DETAILED DESCRIPTION

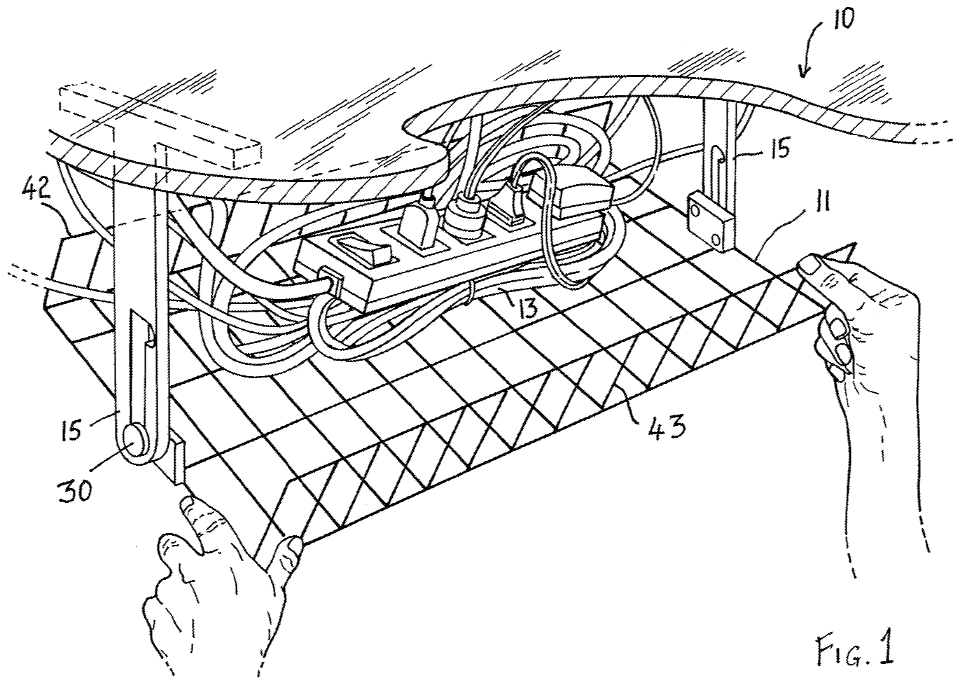

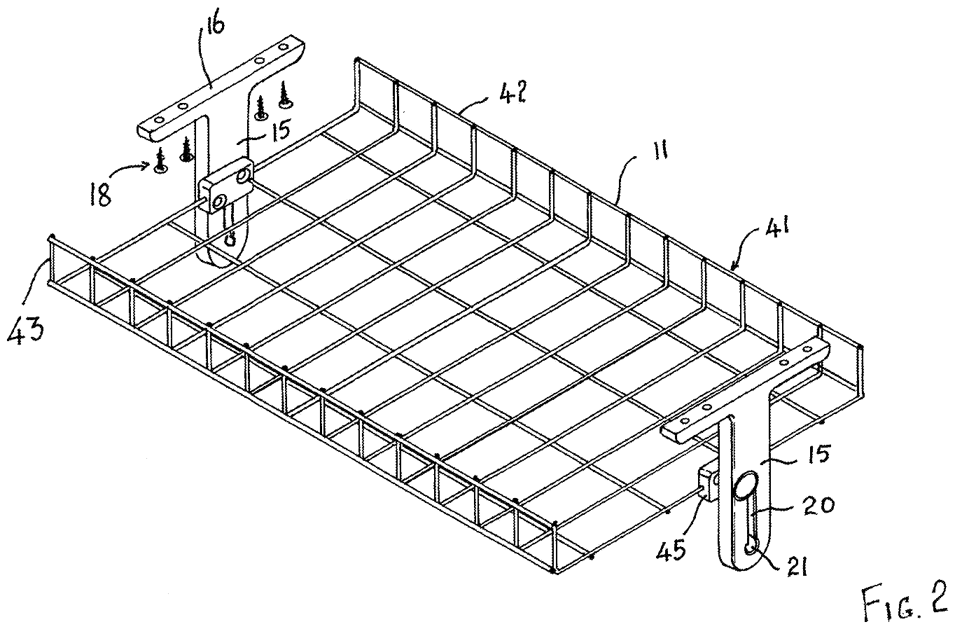

As seen in FIG. 1, a desktop 10 has mounted below it a cable tray 11 which contains ancillary electrical equipment 13 which takes the form of electric cables, power boards, connectors, chargers and the like. The cable tray 11 is supported by means of two T-shaped supports 15. As best seen in FIG. 2, the upper end 16 of the supports 15 is flat and provided with apertures through which the fasteners 18 can be used to secure the supports 15 to the underside of the desktop 10.

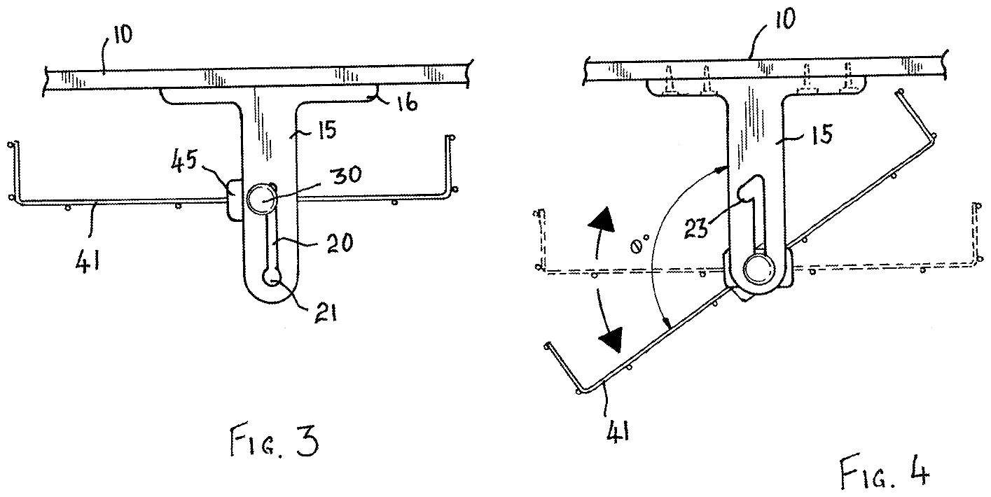

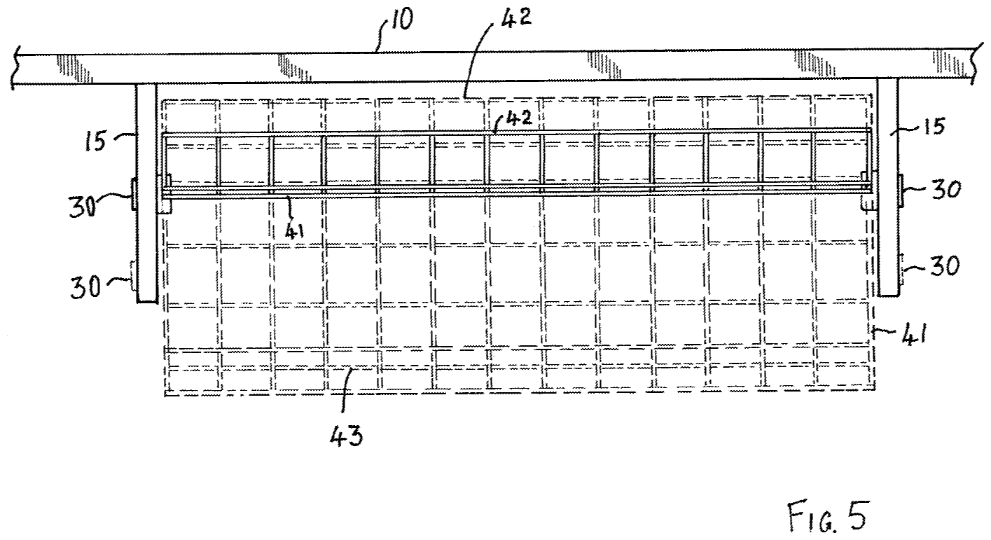

As best seen in FIGS. 3 and 4, tads of the supports 15 is provided with a groove or slot 20 which extends longitudinally. The lower end of the groove 20 is formed into a cylindrical portion 21 which forms a bearing for a stub axle 30 retained in the groove 20. The upper end of the groove 20 comprises a recurvate portion 23 which slopes downwardly relative to the upper end of the support 15. The recurvate portions 23 are of opposite hands and so both extend in the same direction.

The cable tray 11 is fabricated as a wire basket 41 and is preferably dipped in PVC or other plastic material. The wire basket 41 has a front wall 42 and a rear wall 43 but no side walls. As best seen in FIG. 2 a housing 45 is secured to each side of the basket 41. Each stub axle 30 extends from the corresponding housing 45 and is retained in the corresponding groove 20.

It will be apparent that by sliding the stub axles 30 along the grooves 20, the cable tray 11 is movable between an upper storage position as illustrated in FIG. 3, and a lower tiltable access position as illustrated in FIG. 4. In FIG. 3 each stub axle 30 is located in the corresponding upper recurvate portion 23, whereas in FIG. 4 each stub axle is located in the corresponding cylindrical portion 21. In the storage position the wire basket 41 is approximately parallel to the desktop 10 and therefore substantially perpendicular to the T-shaped supports 15. However, in the access position, the wire basket 41 makes an angle θ of approximately 125° relative to the longitudinal axis of the T-shaped supports 15. That is, the basket 41 is tilted by approximately 35° from its rest position.

The access to the basket 41 is improved by firstly permitting the basket 41 to be lowered relative to the desktop 10, and secondly by arranging for the basket 41 to be tilted thereby enabling its contents 13 to be more easily viewed,

The ability for the cable tray I 1/wire basket 41 to tilted when in the lowered position substantially improves the access to the contents 13 of the cable tray 11. Given that the cable tray 11 is positioned under the desktop 10, this ease of access is particularly important since the person desiring the access is either on hands and knees or crouching in order to access the ancillary electrical equipment 13. Often the person seeking access will be a lady dressed in a tight skirt or other constricting garment and so the enhanced access is particularly appreciated by the user.

The foregoing describes only one embodiment of the present invention and modifications, obvious to those skilled in the electrical arts, can be made thereto without departing from the scope of the present invention.

The term “comprising” (and its grammatical variations) as used herein is used in the inclusive sense of “including” or “having” and not its the exclusive sense of “consisting only of”.

1. A cable tray for under desk storage of electric cables, cords, double adapters, connectors, chargers and like superfluous electric equipment not required on the desktop, said cable tray comprising a container having a base, a pair of sides, a front and a rear, adjacent each of said sides is an elongate tray support Which has a longitudinal axis, an upper end shaped to be secured to the underside of said desk. a slot in said tray support extending along said longitudinal axis, and a stub axle connected to the adjacent side and being slidably engaged with said slot, wherein the upper end of each said slot is recurvate whereby by sliding said stub axles along said slots said container is movable between a top storage position in which said stub axles are located in upper recurvate portions of said grooves, and a bottom access position in which said stub axles are located at lower ends of said grooves and in which said container is tiltable about said stub axles to facilitate access to the container contents.

2. The cable tray as claimed in claim 1 wherein said grooves are of substantially equal length and of opposite hands whereby said recurvate portions extend in the same directions.

3. The cable tray as claimed in claim 2 wherein the lower ends of said grooves are substantially cylindrical to form bearings for said stub axles.

4. The cable tray as claimed in claim 1 wherein said elongate tray supports are each substantially T-shaped.

5. The cable tray as claimed in claim 1 wherein said recurvate portions each slope downwardly relative to the upper ends of said elongate tray supports.

6. The cable tray as claimed in claim 1 wherein said container comprises a wire basket.

7. The cable tray as claimed in claim 1 wherein by moving between said storage and access positions, said container tilts through an angle of approximately 35°.

8. A desk incorporating the cable tray as claimed in claim 1.

9. A method of accessing a cable tray located beneath a desk, said method comprising the steps of lowering and tilting said cable tray.
